(19) United States
(12) Patent Application Publication
(10) Pub. No.: US 2023/0043994 A1
(43) Pub. Date: Feb. 9, 2023

(54) THREE-DIMENSIONAL MEASUREMENT DEVICE FOR GENERATING THREE-DIMENSIONAL POINT POSITION INFORMATION

(71) Applicant: FANUC CORPORATION, Yamanashi (JP)

(72) Inventors: Yuuki TAKAHASHI, Yamanashi (JP); Fumikazu WARASHINA, Yamanashi (JP); Minoru NAKAMURA, Yamanashi (JP)

(21) Appl. No.: 17/759,099

(22) PCT Filed: Feb. 12, 2021
(86) PCT No.: PCT/JP2021/005323

§ 371 Date: Jul. 20, 2022

(30) Foreign Application Priority Data
Feb. 17, 2020 (JP) 2020-024652

(51) Int. Cl. G01B 11/24

(52) U.S. Cl. CPC G01B 11/24

(57) ABSTRACT

A three-dimensional measurement device includes a camera for acquiring position information for three-dimensional points on the surface of an object on the basis of the time of flight of light, and a control device. The camera acquires, at a plurality of relative positions of the camera with respect to a workpiece, three-dimensional point position information. A plurality of evaluation regions are defined for the workpiece. The control device specifies, for each evaluation region, the three-dimensional point closest to a reference plane from among three-dimensional points detected in the evaluation region. The control device generates, on the basis of the multiple three-dimensional points specified for the respective evaluation regions, three-dimensional point position information in which multiple pieces of three-dimensional point position information acquired by the camera are combined.

### TECHNICAL FIELD

The present invention relates to a three-dimensional measurement device for generating position information of three-dimensional points.

### BACKGROUND ART

A known measurement device captures an image with a visual sensor and detects a three-dimensional position of an object in accordance with the obtained image. Examples of a known measurement device for detecting a three-dimensional position include a device for detecting a position by scanning a predetermined range with a laser range finder and a device for detecting a position in accordance with the principle of triangulation by capturing images with two cameras (see, for example, Japanese Unexamined Patent Publication No. 2008-264947A and Japanese Unexamined Patent Publication No. 2006-258486A).

Also, a known measurement device for detecting a three-dimensional position is a range camera that emits light from a light source and then receives light reflected by the surface of an object with a light-receiving element (see, for example, International Publication No. WO2018/042801A1). The range camera detects a distance to the object in accordance with time of flight of light and a speed of light per pixel of the light-receiving element.

For example, the range camera irradiates an object with light having an intensity modulated at a predetermined period. The range camera calculates the distance from the range camera to the object in accordance with a phase difference between the light emitted from the light source and the reflected light. This measurement method is called an optical time-of-flight method. The range camera can generate a range image whose color or density is changed according to a distance obtained per pixel.

### CITATION LIST

### Patent Literature

[PTL 1] Japanese Unexamined Patent Publication No. 2008-264947A

[PTL 2] Japanese Unexamined Patent Publication No. 2006-258486A

[PTL 3] International Publication No. WO2018/042801A1

### SUMMARY OF THE INVENTION

### Technical Problem

A range camera that captures an image in an optical transition time method calculates a distance from the range camera to the object per pixel. This enables a three-dimensional point corresponding to a pixel to be set on the surface of the object. The position of the three-dimensional point corresponds to the position on the surface of the object.

The light-receiving element of the range camera preferably receives light that is reflected from the surface of the object and travels through one path. However, the shape of the object may cause light emitted from the light source to be reflected at a plurality of positions and to return to the range camera. For example, light may be reflected at a position different from a desired position and then reflected at the desired position and returned to the range camera. The light-receiving element may receive light reflected through a plurality of paths. Such a plurality of paths is referred to as multipath.

When the light-receiving element receives light traveling through a plurality of paths, the distance to the object detected by the range camera is increased. The distance to the object detected in each pixel varies depending on the reflection form of light. Accordingly, the range camera may not be able to set, at a correct position, a three-dimensional point to be set on the surface of the object. For example, the distances to the object detected in some pixels are increased, and the surface of the object may be detected as a concave shape in spite of actually being flat. As described above, when reflected light is received through multipath, the range camera cannot accurately detect the position of a three-dimensional point on the surface of the object, and thus reducing the influence of multipath is preferable.

### Solution to Problem

A three-dimensional measurement device of the present disclosure includes a range camera that acquires position information of three-dimensional points of a surface of an object in accordance with time of flight of light, and a processing device that processes the position information of the three-dimensional points acquired by the range camera. The range camera acquires the position information of the three-dimensional points at a plurality of relative positions and orientations of the range camera to the object. The processing device includes a setting unit that sets a plurality of evaluation regions to the object for evaluating positions of three-dimensional points corresponding to the surface of the object. The processing device includes a determination unit that determines, in each of the evaluation regions, a three-dimensional point closest to a predetermined reference plane, a reference point, or a reference line of a plurality of the three-dimensional points detected within each of the evaluation regions. The processing device includes a generation unit that generates, in accordance with a plurality of three-dimensional points determined for each of the evaluation regions by the determination unit, position information of three-dimensional points obtained by synthesizing pieces of position information of a plurality of the three-dimensional points acquired by the range camera.

### Advantageous Effects of Invention

An aspect of the present disclosure allows for providing a three-dimensional measurement device that reduces the influence of multipath.

### BRIEF DESCRIPTION OF DRAWINGS

FIG. 1 is a side view of a first robot apparatus of an embodiment.

FIG. 2 is a block diagram of the first robot apparatus.

FIG. 3 is a perspective view of a first workpiece of an embodiment.

FIG. 4 is a partial cross-sectional view of a camera and a workpiece when reflected light is received though multipath.

FIG. 5 is a schematic diagram illustrating a phase of light received in a pixel of a light-receiving element of a camera.

FIG. 6 is a range image of a workpiece acquired when no light reception through multipath is generated.

FIG. 7 is a range image when light reception through multipath is generated.

FIG. 8 is a flowchart illustrating the control of a first robot apparatus.

FIG. 9 is a partial cross-sectional view of a camera and a workpiece when a first range image is captured at a first position of the camera.

FIG. 10 is a partial cross-sectional view of a camera and a workpiece when a second range image is captured at a second position of the camera.

FIG. 11 is a cross-sectional view of a workpiece for illustrating a position of three-dimensional point when three-dimensional points in a first range image and a three-dimensional point in a second range image are combined.

FIG. 12 is a perspective view of a camera and a workpiece for illustrating an evaluation range in which evaluation regions are arranged.

FIG. 13 is a perspective view of an evaluation region in a first robot apparatus.

FIG. 14 is a cross-sectional view of a workpiece for illustrating a three-dimensional point determined by a determination unit.

FIG. 15 is a perspective view of a light-receiving element and an optical center of a camera for illustrating a size of an evaluation region.

FIG. 16 is a diagram illustrating a position of a camera when a range image is captured.

FIG. 17 is a perspective view of a second workpiece of an embodiment.

FIG. 18 is a perspective view of a third workpiece and a table of an embodiment.

FIG. 19 is a side view of a second robot apparatus of an embodiment.

FIG. 20 is a partial cross-sectional view of a camera and a workpiece for illustrating positions of three-dimensional points when a three-dimensional point in a first range image and a three-dimensional point in a second range image are combined.

FIG. 21 is a side view of an inspection device of an embodiment.

FIG. 22 is a block diagram of an inspection device of an embodiment.

FIG. 23 is a partial cross-sectional view of a workpiece and a camera when a first range image is captured in a third robot apparatus of an embodiment.

FIG. 24 is a partial cross-sectional view of a workpiece and a camera when a second range image is captured in a third robot apparatus.

FIG. 25 is a partial cross-sectional view of a camera and a workpiece for illustrating positions of three-dimensional points when a three-dimensional point in a first range image and a three-dimensional point in a second range image are combined.

FIG. 26 is a perspective view of a camera and a workpiece for illustrating an evaluation range in which evaluation regions are arranged in a third robot apparatus.

FIG. 27 is a perspective view of an evaluation region in a third robot apparatus.

FIG. 28 is a cross-sectional view of a workpiece for illustrating a three-dimensional point determined by a determination unit in a third robot apparatus.

FIG. 29 is a perspective view of a light-receiving element and an optical center for illustrating a size of an evaluation region in a third robot apparatus.

FIG. 30 is a perspective view illustrating orientations of a camera when a plurality of range images is captured in a third robot apparatus.

FIG. 31 is a side view of a camera and a workpiece in a fourth robot apparatus of an embodiment.

FIG. 32 is a partial cross-sectional view of a camera and a workpiece in a fifth robot apparatus of an embodiment.

FIG. 33 is a perspective view of a camera and a workpiece for illustrating an evaluation range in which evaluation regions are arranged in a fifth robot apparatus.

FIG. 34 is a perspective view of an evaluation region in a fifth robot apparatus.

### DESCRIPTION OF EMBODIMENTS

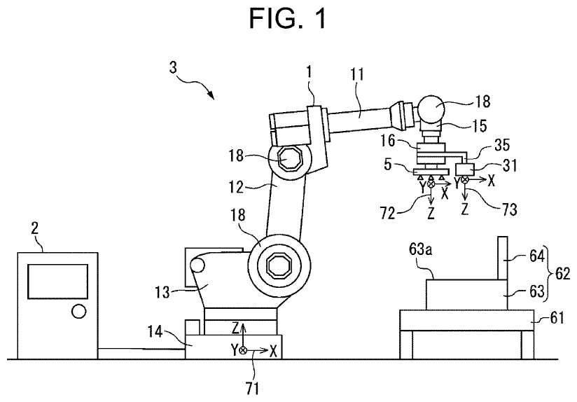

A three-dimensional measurement device of an embodiment will be described with reference to FIG. 1 to FIG. 34. The three-dimensional measurement device of the present embodiment includes a range camera that acquires position information of three-dimensional points of a surface of an object in accordance with time of flight of light. The three-dimensional measurement device generates position information of three-dimensional points corresponding to a surface of a workpiece in accordance with pieces of position information of three-dimensional points acquired at a plurality of positions and orientations. In the present embodiment, each of robot apparatuses and inspection device functions as a three-dimensional measurement device.

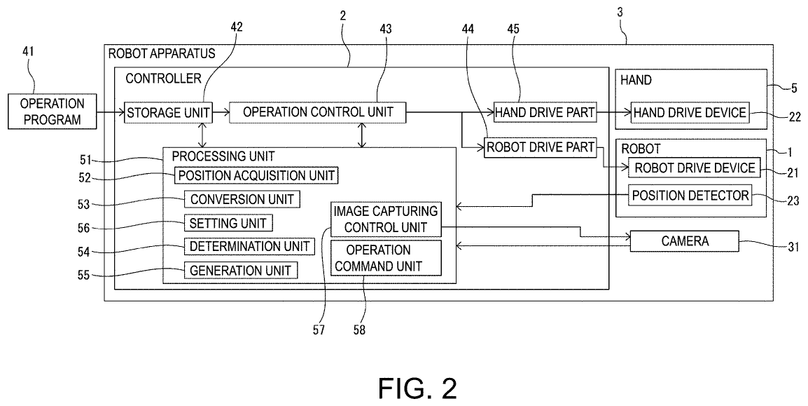

FIG. 1 is a side view of a first robot apparatus of the present embodiment. FIG. 2 is a block diagram of a first robot apparatus of the present embodiment. With reference to FIG. 1 and FIG. 2, a robot apparatus 3 includes a hand 5 that grasps a workpiece 62 and a robot 1 that moves the hand 5. The robot apparatus 3 includes a controller 2 that controls the robot apparatus 3. Further, the robot apparatus 3 includes a platform 61 on which the workpiece 62 is placed.

The hand 5 is an end effector that holds and releases the workpiece 62. The hand 5 of the present embodiment is a suction hand that holds a surface 63a of the workpiece 62 by sucking. An end effector attached to the robot 1 is not limited to this aspect, and any work tool appropriate for operations performed by the robot apparatus 3 may be employed. For example, as an end effector, a work tool for performing welding, a work tool for applying a sealing material to a surface of a workpiece, or the like can be employed. That is, the three-dimensional measurement device of the present embodiment can be applied to a robot apparatus that performs any operations. Alternatively, instead of attaching a work tool to the robot 1, a camera 31 may be attached to the robot 1.

The robot 1 of the present embodiment is an articulated robot having a plurality of joints 18. The robot 1 includes an upper arm 11 and a lower arm 12. The lower arm 12 is supported by a turning base 13. The turning base 13 is supported by a base 14. The robot 1 includes a wrist 15 that is coupled to an end portion of the upper arm 11. The wrist 15 includes a flange 16 that secures the hand 5. The components of the robot 1 are formed so as to rotate around a predetermined drive axis. The robot is not limited to the aspect described above, and any robot that can move a work tool or a workpiece may be employed.

The robot apparatus 3 includes the camera 31 as a range camera that acquires position information of three-dimensional points corresponding to a surface of the workpiece 62 as an object. The camera 31 of the present embodiment is a Time of Flight (TOF) camera that acquires position information of three-dimensional points in accordance with time of flight of light. The TOF camera includes a light-receiving element having a plurality of pixels arranged two-dimensionally. The light-receiving element includes a Charge-Coupled Device (CCD), a Complementary Metal-Oxide Semiconductor (CMOS), or the like.

In the first robot apparatus 3, the camera 31 is supported by the robot 1. The camera 31 is fixed to the flange 16 via a support member 35. The camera 31 moves with the hand 5. The camera 31 is disposed so as to be able to capture an image of a part held by the hand 5 in the workpiece 62.

The camera 31 can acquire position information of three-dimensional points corresponding to a surface of an object in the form of a range image or a three-dimensional map. A range image represents position information of three-dimensional points in an image. In a range image, positions on a surface of an object or distances from the camera 31 are represented by densities or colors of respective pixels. On the other hand, a three-dimensional map represents three-dimensional information as a set of coordinate values (x, y, z) of three-dimensional points measured. In an aspect of the present embodiment, position information of three-dimensional points will be described by using a range image taken as an example.

The robot 1 of the present embodiment includes a robot drive device 21 that drives components such as the upper arm 11. The robot drive device 21 includes a plurality of drive motors that drives the upper arm 11, the lower arm 12, the turning base 13, and the wrist 15. The hand 5 includes a hand drive device 22 that drives the hand 5. The hand drive device 22 of the present embodiment drives the hand 5 by air pressure. The hand drive device 22 includes a pump, an electromagnetic valve, and the like for depressurizing an inner space of a suction pad.

The controller 2 controls the robot 1 and the hand 5. The controller 2 has an arithmetic processing device (computer) which includes a Central Processing Unit (CPU) as a processor. The arithmetic processing device has a Random Access Memory (RAM), a Read Only Memory (ROM), or the like, which are mutually connected to the CPU via a bus. The robot 1 of the present embodiment automatically conveys the workpiece 62 in accordance with an operation program 41. The robot drive device 21 and the hand drive device 22 are controlled by the controller 2.

The controller 2 includes a storage unit 42 that stores information regarding the control of the robot apparatus 3. The storage unit 42 can be configured of a storage medium capable of storing information, for example, a volatile memory, a non-volatile memory, a hard disk, or the like. The operation program 41 generated in advance for operating the robot 1 is input to the controller 2. The operation program 41 is stored in the storage unit 42.

The controller 2 includes an operation control unit 43 that sends an operation command The operation control unit 43 sends an operation command for driving the robot 1 in accordance with the operation program 41 to a robot drive part 44. The robot drive part 44 includes an electrical circuit that drives the drive motors and supplies electricity to the robot drive device 21 in accordance with the operation command Further, the operation control unit 43 sends an operation command for driving the hand drive device 22 to a hand drive part 45. The hand drive part 45 includes an electrical circuit that drives the pump and the like and supplies electricity to the pump and the like in accordance with the operation command The operation control unit 43 corresponds to a processor that is driven in accordance with the operation program 41. The processor functions as the operation control unit 43 by reading the operation program 41 and performing the control defined in the operation program 41.

The robot 1 includes a state detector for detecting a position and an orientation of the robot 1. The state detector of the present embodiment includes a position detector 23 attached to the drive motor of each drive axis in the robot drive device 21. Based on an output from the position detector 23, a position and an orientation of the robot 1 are detected. The state detector is not limited to a position detector attached to the drive motor, and any detector capable of detecting a position and an orientation of the robot 1 can be employed.

A world coordinate system 71 that is immovable in response to a change in a position and an orientation of the robot 1 is set to the robot apparatus 3 of the present embodiment. In the example illustrated in FIG. 1, an origin of the world coordinate system 71 is located at the base 14 of the robot 1. The world coordinate system 71 is also referred to as a reference coordinate system. In the world coordinate system 71, a position of the origin is fixed, and further, the directions of coordinate axes are fixed. Even when the position and the orientation of the robot 1 are changed, the position and the orientation of the world coordinate system 71 are not changed. The world coordinate system 71 has an X-axis, a Y-axis, and a Z-axis which are orthogonal to each other as coordinate axes. Additionally, a W-axis is set as a coordinate axis around the X- axis. A P-axis is set as a coordinate axis around the Y-axis. An R-axis is set as a coordinate axis around the Z-axis.

Additionally, in the robot apparatus 3, a tool coordinate system 72 that has an origin set at any position of the work tool is set. The tool coordinate system 72 is a coordinate system whose position and orientation are changed with the hand 5. In the present embodiment, the origin of the tool coordinate system 72 is set at a tool tip point. The origin of the tool coordinate system 72 is located on the rotation axis of the flange 16. The tool coordinate system 72 has an X-axis, a Y-axis, and a Z-axis that are orthogonal to each other. The tool coordinate system 72 has a W-axis around the X-axis, a P-axis around the Y-axis, and an R-axis around the Z-axis.

When the position and the orientation of the robot 1 are changed, the position of the origin and the orientation of the tool coordinate system 72 are changed. For example, the position of the robot 1 corresponds to a position of the tool tip point (the position of the origin of the tool coordinate system 72). Furthermore, the orientation of the robot 1 corresponds to the orientation of the tool coordinate system 72 with respect to the world coordinate system 71.

Further, in the robot apparatus 3, a camera coordinate system 73 is set to the camera 31. The camera coordinate system 73 is a coordinate system whose position and orientation are changed with the camera 31. An origin of the camera coordinate system 73 of the present embodiment is set at the optical center of the camera 31. The camera coordinate system 73 has an X-axis, a Y-axis, and a Z-axis that are orthogonal to each other. The camera coordinate system 73 of the present embodiment is set such that the Z-axis overlaps the optical axis of the camera 31.

The robot apparatus 3 of the present embodiment functions as a three-dimensional measurement device that detects the workpiece 62. The three-dimensional measurement device includes the camera 31 and a processing device that processes position information of three-dimensional points acquired by the camera 31. The controller 2 includes a processing unit 51 that processes position information of three-dimensional points. The processing unit 51 functions as the processing device. The processing unit 51 includes a position acquisition unit 52 that acquires position information of three-dimensional points from the camera 31. The processing unit 51 includes a conversion unit 53 that converts the position information of three-dimensional points relative to the camera 31 into the position information of three-dimensional points relative to the workpiece 62. The processing unit 51 includes a setting unit 56 that sets a plurality of evaluation regions for evaluating a position of a three-dimensional point corresponding to the surface of the workpiece 62 for the workpiece 62. The processing unit 51 includes a determination unit 54 that determines a three-dimensional point closest to a reference plane, a reference point, or a reference line as a reference in the evaluation region for evaluating a position of a three-dimensional point. The processing unit 51 includes a generation unit 55 that generates position information of three-dimensional points obtained by synthesizing pieces of position information of a plurality of three-dimensional points acquired by the camera 31.

The processing unit 51 includes an operation command unit 58 that generates an operation command for driving the robot 1 in accordance with the synthesized position information of three-dimensional points. The processing unit 51 includes an image capturing control unit 57 that sends a command for capturing an image to the camera 31.

The processing unit 51 described above corresponds to a processor that is driven in accordance with the operation program 41. In particular, each of the position acquisition unit 52, the conversion unit 53, the setting unit 56, the determination unit 54, and the generation unit 55 corresponds to a processor that is driven in accordance with the operation program 41. In addition, each of the operation command unit 58 and the image capturing control unit 57 corresponds to the processor that is driven in accordance with the operation program 41. The processor functions as each unit by reading the operation program 41 and performing the control defined in the operation program 41.

The robot apparatus 3 includes a movement device that moves either of the workpiece 62 or the camera 31 so as to change a relative position of the camera 31 to the workpiece 62. In the first robot apparatus 3, the robot 1 functions as the movement device that moves the camera 31.

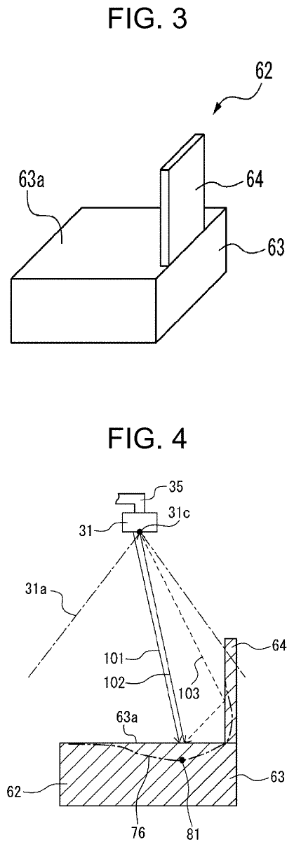

FIG. 3 illustrates a perspective view of a first workpiece of the present embodiment. The first workpiece 62 of the present embodiment includes a plate portion 63 formed in a plate shape, and a wall portion 64 erected from the plate portion 63. The plate portion 63 includes a surface 63a having a planar shape. The wall portion 64 is disposed on an end portion of the surface 63a. The surface 63a of the workpiece 62 is held by the hand 5.

With reference to FIG. 1 to FIG. 3, the first robot apparatus 3 captures a range image of the workpiece 62 with the camera 31 before the hand 5 holds the workpiece 62. The image capturing control unit 57 sends a command for capturing an image to the camera 31. The robot apparatus 3 captures an image at a plurality of positions of the camera 31. The processing unit 51 detects the position of the surface 63a of the workpiece 62 in accordance with a plurality of images captured by the camera 31.

The operation command unit 58 generates an operation command for the robot 1 in accordance with the position of the surface 63a of the workpiece 62 so that the hand 5 can hold the surface 63a. The operation command unit 58 sends the operation command to the operation control unit 43. The operation control unit 43 changes the position and the orientation of the robot 1 in accordance with the operation command, and then holds the workpiece 62 with the hand 5. Then, the robot 1 conveys the workpiece 62 to a target position in accordance with the operation program 41.

Next, the influence of the reflected light received through multipath by the camera 31 will be described. FIG. 4 is a partial cross-sectional view of a camera and a workpiece for illustrating an influence of multipath. The camera 31 detects the position of the surface 63a of the workpiece 62. The camera 31 has an image capturing region 31a in which a range image can be captured. Light is emitted from a light source of the camera 31 as indicated by an arrow 101. Light reflected by the surface 63a of the workpiece 62 returns toward the light-receiving element of the camera 31 as indicated by an arrow 102. When the light-receiving element receives only the light reflected through the path indicated by the arrow 101 and the arrow 102, the exact position of the surface 63a of the workpiece 62 can be detected.

However, light emitted from the light source may be reflected by the wall portion 64 and then directed toward the surface 63a as indicated by an arrow 103. Subsequently, the light returns to the light-receiving element as indicated by the arrow 102. In this manner, the light of the light source travels and returns to the light-receiving element through a plurality of paths including the path indicated by the arrow 101 and the path indicated by the arrow 103. That is, the light-receiving element receives light returned through multipath. When light reflected multiple times is included, the time of flight of the light detected by the light-receiving element is detected as being longer. Although two paths are illustrated in FIG. 4 for explanation, light reflected at various positions of the wall portion 64 actually is directed toward the surface 63a, and the light-receiving element may receive beams of light traveling through many paths.

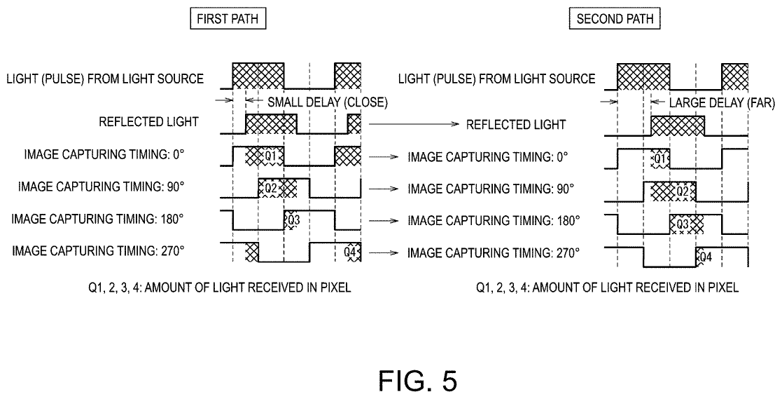

FIG. 5 illustrates an explanatory diagram of a method of measuring a distance from a camera to a workpiece. With reference to FIG. 4 and FIG. 5, a first path corresponds to the path indicated by the arrows 101 and 102. A second path corresponds to the path indicated by the arrows 103 and 102.

With reference to the diagram of the first path, as a method of measuring time of flight of light, the camera 31 of the present embodiment detects a phase delay of a reflected light with respect to light emitted from the light source. The camera 31 performs image capturing at a plurality of timings having different phases with respect to the light emitted from the light source. In the example illustrated in FIG. 5, image capturing is repeated at four types of image capturing timings (0°, 90°, 180°, and 270°). In FIG. 5, received light amounts Q1, Q2, Q3, and Q4 in one pixel of the light-receiving element are indicated. At this time, a distance L to an object corresponding to a pixel can be calculated, for example, according to Equation (1) below. In Equation (1), c is the speed of the light, f is the modulation frequency of the light emitted from the light source.

$$\begin{matrix}Equation 1 & \\ L = \frac{c}{4 π f} \cdot {tan}^{- 1} ( \frac{{Q}_{2} - {Q}_{4}}{{Q}_{1} - {Q}_{3}} ) & ( 1 )\end{matrix}$$

With reference to the diagram of the second path, when a light path gets longer, the timing of receiving light emitted from the light source gets later than the timing of receiving light through the first path. The received light amounts Q1, Q2, Q3, and Q4 of the light received at the four types of image capturing timings are different from those through the first path. For example, at the image capturing timing of 0°, the received light amount Q1 through the second path is smaller than the received light amount Q1 through the first path. When a distance L is calculated according to Equation (1) above, the distance L corresponding to each pixel is longer than the distance L through the first path.

When the light-receiving element receives light reflected through multipath, for example, the light-receiving element simultaneously receives light traveling through the first path and light traveling through the second path. That is, the light-receiving element detects a received light amount obtained by combining the received light amount through the first path and the received light amount through the second path. As a result, when light reflected through multipath is received, the distance L is longer than the distance corresponding to the first path. Specifically, the distance is a distance between the distance corresponding to the light traveling through the first path and the distance corresponding to the light traveling through the second path. A three-dimensional point 81 detected in correspondence to one pixel is detected at a position away from the surface 63a. A three-dimensional point 81 is detected for each pixel. A detected surface 76 including a plurality of three-dimensional points 81 has a shape different from the actual shape of the surface 63a.

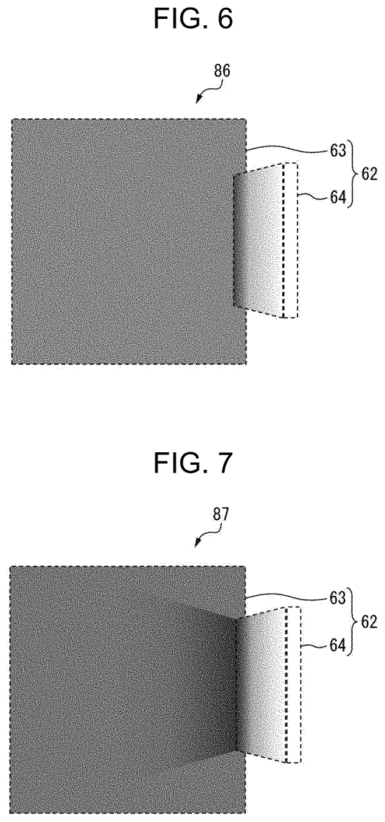

FIG. 6 illustrates an example of a range image without influence of multipath. FIG. 7 illustrates an example of a range image with an influence of multipath generated. In FIG. 6 and FIG. 7, the shape of the workpiece 62 is indicated by dashed lines for reference. In a range image of the present embodiment, the deeper the color is, the farther the distance from the camera 31 is. With reference to FIG. 6, in a range image 86, the color density is substantially the same over the entire surface of the plate portion 63 of the workpiece 62. On the surface of wall portion 64, the closer the distance to the camera 31 is, the lighter the color is. With reference to FIG. 7, a range image 87 is obtained by receiving light through multipath. On the surface of the plate portion 63, regions with deeper colors are generated in the vicinity of the wall portion 64. When the position of the surface of the plate portion 63 is detected in accordance with such a range image, the exact position may not be detected. As a result, the robot apparatus 3 may fail to control the holding of workpiece 62. The three-dimensional measurement device of the present embodiment performs the control for reducing such an influence of multipath.

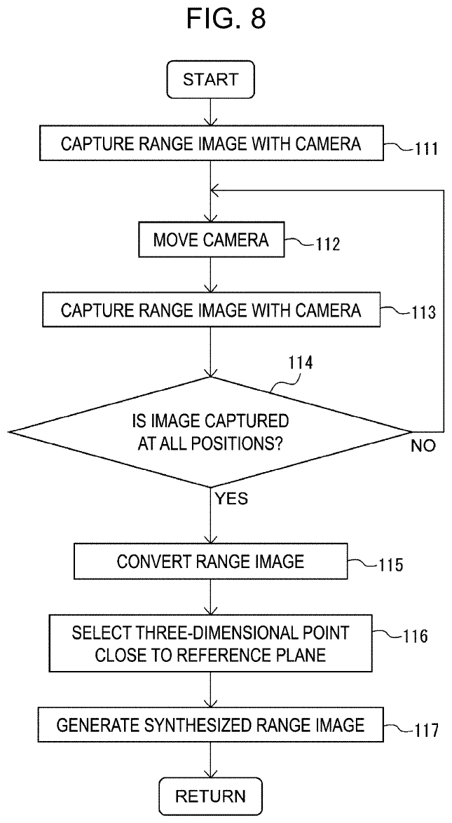

FIG. 8 illustrates a flowchart for describing the control of the first robot apparatus as a three-dimensional measurement device. The first robot apparatus 3 captures a plurality of range images while changing the position of the camera 31. By synthesizing range images obtained at a plurality of positions, a range image with reduced multipath is generated.

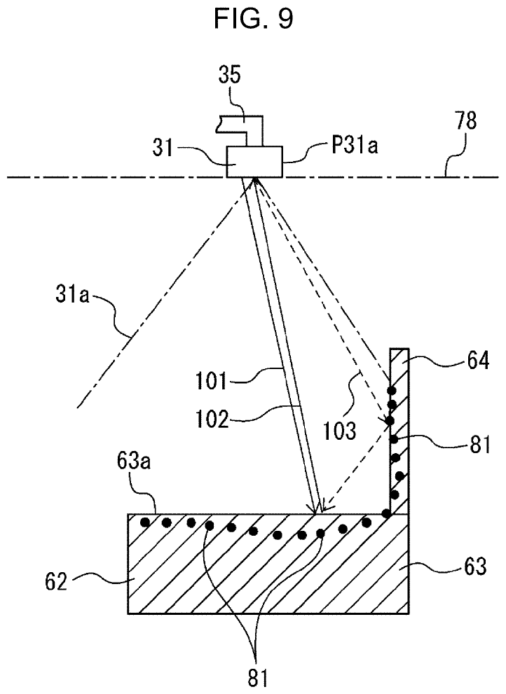

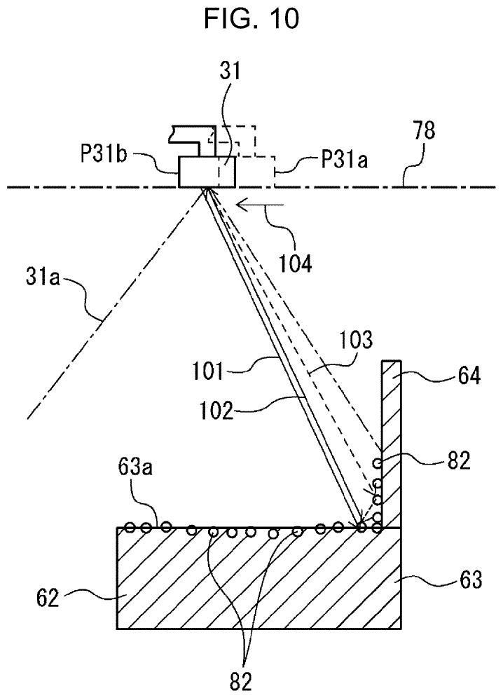

In step 111, the controller 2 places the camera 31 at a predetermined first position, and then the image capturing control unit 57 captures a first range image with the camera 31. FIG. 9 illustrates a partial cross-sectional view of the camera and the workpiece when the camera is placed at the first position. The relative position of the camera 31 to the workpiece 62 is predetermined. In the first robot apparatus 3, the robot 1 changes the position and the orientation so that the camera 31 is translated along a predetermined movement plane 78. For example, the camera 31 moves so as to arrange the optical center of the camera 31 on the movement plane 78. The camera 31 is placed at a position along the movement plane 78. In the first robot apparatus 3, the orientation of the camera 31 is kept constant.

The robot 1 places the camera 31 at a first position P31a. The camera 31 is preferably placed so that at least a part of the portion to be detected in the workpiece 62 is arranged inside the image capturing region 31a of the camera 31. In other words, the part of the workpiece 62 to be detected is preferably included in an image captured by the camera 31.

The camera 31 detects the position information of a three-dimensional point 81 per pixel. FIG. 9 illustrates three-dimensional points 81 with respect to the cross-sectional shape of the workpiece 62 obtained by cutting the workpiece 62 by one plane. The position information of the three-dimensional points 81 output from the camera 31 is represented in the camera coordinate system 73. For example, the position information of the three-dimensional points 81 is represented by the coordinate value of the X-axis, the coordinate value of the Y-axis, and the coordinate value of the Z-axis in the camera coordinate system 73. Since the light received by the camera 31 is affected by multipath, the positions of the three-dimensional points 81 may be away from the surface 63a of the plate portion 63.

With reference to FIG. 2, the position acquisition unit 52 of the processing unit 51 acquires the first range image of the workpiece 62 from the camera 31. Further, the position acquisition unit 52 acquires the position and the orientation of the robot 1 at the time of capturing the first range image from the position detector 23. The position acquisition unit 52 stores the first range image with the position and the orientation of the robot 1 in the storage unit 42.

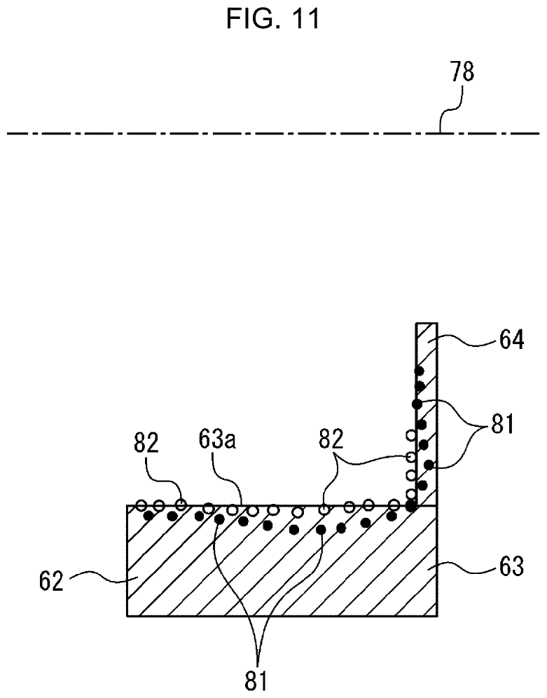

With reference to FIG. 8, in step 112, the controller 2 moves the camera 31 by changing the position and the orientation of the robot 1. FIG. 10 illustrates a partial cross-sectional view of the camera and the workpiece when the camera is placed at a second position. The robot 1 moves the camera 31 along the movement plane 78 as indicated by an arrow 104. The robot 1 moves the camera 31 two-dimensionally along the movement plane 78. The camera 31 is placed at a second position P31b.

With reference to FIG. 8, in step 113, the image capturing control unit 57 captures a second range image of the workpiece 62 with the camera 31. With reference to FIG. 2, the position acquisition unit 52 acquires the second range image of the workpiece 62 from the camera 31. Further, the position acquisition unit 52 acquires the position and the orientation of the robot 1 at the time of capturing the second range image from the position detector 23. The position acquisition unit 52 stores the second range image with the position and the orientation of the robot 1 in the storage unit 42.

With reference to FIG. 10, the camera 31 detects three-dimensional points 82 by capturing the image at the second position P31b. The light-receiving element receives light traveling through a path indicated by arrows 103 and 102 as well as light traveling through a path indicated by arrows 101 and 102. The influence of multipath is also generated on the positions of the three-dimensional point 82. However, the region of the wall portion 64 included in the image capturing region 31a is reduced. For that reason, the influence of multipath on the position of the three-dimensional point 82 is smaller than that on the position of the three-dimensional point 81 acquired by the camera 31 placed at the first position P31a. The three-dimensional points 82 close to the surface 63a of the plate portion 63 are obtained.

With reference to FIG. 8, in step 114, the processing unit 51 determines whether or not the image capturing has been performed at all the predetermined positions of the camera 31. In step 114, when there is a remaining position at which the image capturing is to be performed by the camera 31, the control returns to step 112. Then, the control from step 112 to step 114 is repeated.

In step 114, when the image capturing has been performed at all the positions of the camera 31, the control proceeds to step 115. In this example, the camera 31 captures images at two positions. Since the image capturing has been performed at all the positions of the camera 31, the control proceeds to step 115. Note that, in the present embodiment, the camera captures images at two positions, but the embodiment is not limited to this. The camera may capture images at three or more positions.

With reference to FIG. 2 and FIG. 8, in step 115, the conversion unit 53 of the processing unit 51 converts the range images captured at the plurality of positions P31a and P31b of the camera 31. The conversion unit 53 converts the position information of the three-dimensional points relative to the camera 31 into the position information relative to the workpiece 62. The conversion unit 53 converts the position information of the three-dimensional points represented in the camera coordinate system 73 into the position information of the three-dimensional points represented in the world coordinate system 71. At this time, the conversion unit 53 converts the range images captured at the respective positions P31a and P31b in accordance with the position and the orientation of the robot 1. The positions of the three-dimensional points 81 and 82 in each of the first range image and the second range image are represented by the coordinate values in the world coordinate system 71.

Next, in step 116, the determination unit 54 of the processing unit 51 determines the three-dimensional points close to the surface 63a of the workpiece 62 of the three-dimensional points included in the first range image and the second range image.

FIG. 11 illustrates a partial cross-sectional view of the workpiece in which the three-dimensional points in the first range image and the three-dimensional points in the second range image are combined. The determination unit 54 arranges the three-dimensional points included in all the range images to one surface of the workpiece 62. In this example, the determination unit 54 arranges the three-dimensional points 81 in the first range image and the three-dimensional points 82 in the second range image to the surface of the workpiece 62. The plurality of three-dimensional points 81 and 82 corresponding to the surface 63a of the workpiece 62 are arranged.

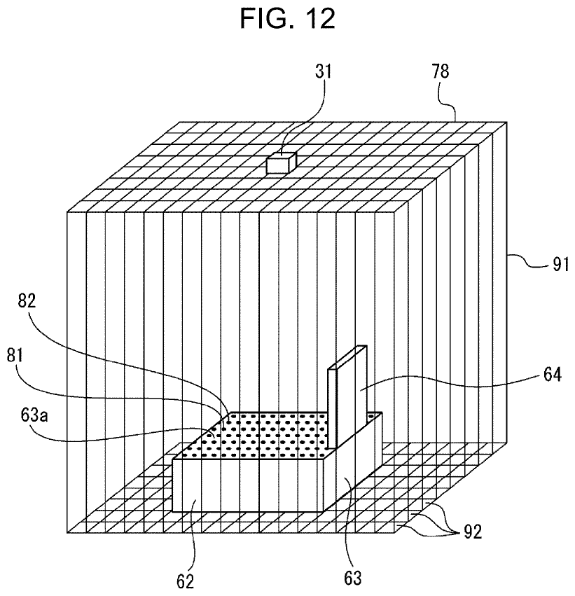

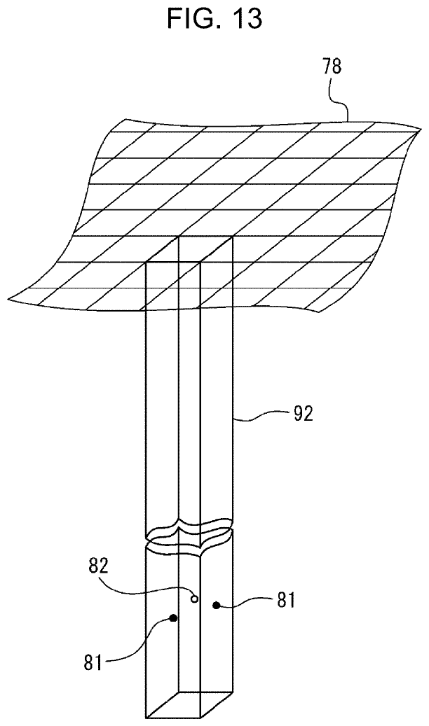

FIG. 12 illustrates a perspective view of the camera and the workpiece for describing an evaluation range in which evaluation regions are arranged in the first robot apparatus. FIG. 13 illustrates a perspective view of an evaluation region in the first robot apparatus. With reference to FIG. 12 and FIG. 13, the plurality of three-dimensional points 81 and 82 are arranged on the surface 63a of the workpiece 62 and in the vicinity of the surface 63a. The setting unit 56 of the processing unit 51 sets an evaluation range 91 that is a range in which the three-dimensional points 81 and 82 are evaluated. The setting unit 56 sets a plurality of evaluation regions 92 to the workpiece 62 in order to evaluate the positions of the three-dimensional points 81 and 82 corresponding to the surface 63a of the workpiece 62. The evaluation range 91 includes the plurality of evaluation regions 92.

In the present embodiment, the evaluation regions 92 and the evaluation range 91 are set in advance and stored in the storage unit 42. The setting unit 56 acquires the evaluation regions 92 and the evaluation range 91 from the storage unit 42 and sets the evaluation regions 92 and the evaluation range 91 to the workpiece 62. The evaluation range 91 is preferably formed so as to include a part of the workpiece 62 to be evaluated. In the present embodiment, the evaluation range 91 is set so as to include the surface 63a of the workpiece 62 to be evaluated. Further, in the present embodiment, the evaluation range 91 is set so as to include the workpiece 62.

The evaluation regions 92 of the present embodiment are regions obtained by dividing the evaluation range 91 into a plurality of regions. A reference plane is set in order to evaluate the positions of the three-dimensional points 81 and 82. Any plane can be used as the reference plane. The reference plane is preferably the movement plane 78 or a plane parallel to the movement plane 78. In the first robot apparatus 3, the movement plane 78 is set as the reference plane.

As the evaluation region of the present embodiment, a region extending from a reference such as the reference plane is used. The evaluation region 92 is formed so as to extend from the movement plane 78 in a perpendicular direction. The evaluation region 92 of the present embodiment is formed in a rectangular parallelepiped shape. The evaluation region is not limited to this embodiment and may extend in a direction inclined with respect to the reference plane. In addition, an evaluation region having any shape can be used. For example, an evaluation region may have any polygonal shape.

The determination unit 54 detects the three-dimensional points 81 and 82 included in the respective evaluation regions 92 in accordance with the positions of the three-dimensional points 81 and 82. Here, when the influence of multipath is generated as described above, the distance from the camera 31 to the three-dimensional point gets longer. Therefore, it can be determined that the shorter the distance from the movement plane 78 as the reference plane to the three-dimensional point is, the smaller the influence of multipath is.

The determination unit 54 determines the three-dimensional point closest to the movement plane 78 of the plurality of three-dimensional points 81 and 82 arranged inside the evaluation region 92. The determination unit 54 calculates the distance from the movement plane 78 to each of the three-dimensional points 81 and 82. In the example illustrated in FIG. 13, one three-dimensional point 82 is closer to the movement plane 78 than two three-dimensional points 81. Thus, the determination unit 54 determines the three-dimensional point 82. Then, the determination unit 54 performs the control for excluding the two three-dimensional points 81 from a set of three-dimensional points. In this manner, the determination unit 54 performs the control for determining one three-dimensional point closest to the reference plane for each of the evaluation regions 92.

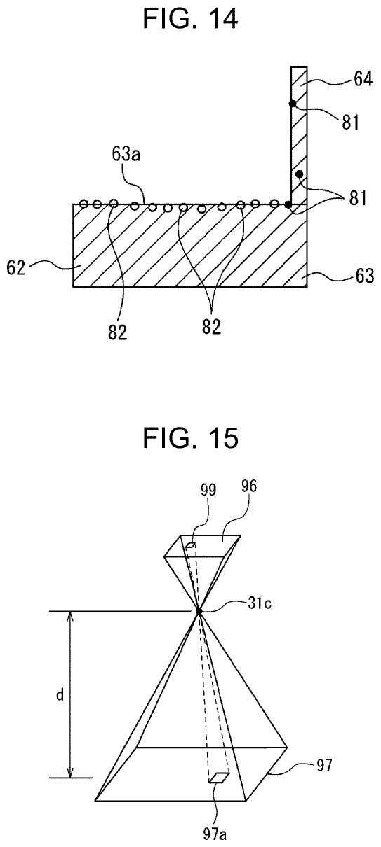

FIG. 14 illustrates a cross-sectional view of the workpiece for indicating the positions of the three-dimensional points after the determination by the determination unit. The three-dimensional points 81 and 82 closest to the movement plane 78 are extracted among the plurality of three-dimensional points 81 and 82 illustrated in FIG. 11 in each of the evaluation regions 92. By determining the three-dimensional points 81 and 82 by the determination unit 54 as described above, it is possible to leave the three-dimensional points close to the surface 63a. That is, the three-dimensional points that are less affected by multipath can be left.

Here, the three-dimensional points 81 remaining on the surface of the wall portion 64 are different from the three-dimensional points corresponding to the surface 63a. Thus, the determination unit 54 may perform the control for removing the three-dimensional points on the wall portion 64. For example, an approximate position of the surface 63a can be defined in advance. Then, the determination unit 54 can controls to remove three-dimensional points that deviate from a predetermined range from the position of the surface 63a.

With reference to FIG. 8, in step 117, the generation unit 55 of the processing unit 51 generates position information of three-dimensional points obtained by synthesizing a plurality of pieces of position information of three-dimensional points in accordance with the plurality of three-dimensional points 81 and 82 determined by the determination unit 54. For example, the generation unit 55 can generate a range image by all the three-dimensional points determined by the determination unit 54. Alternatively, the generation unit 55 may generate position information of three-dimensional points in the form of three-dimensional map. In this way, the processing unit 51 can generate position information of three-dimensional points less affected by multipath in accordance with pieces of position information of three-dimensional points captured at a plurality of positions of the camera 31.

With reference to FIG. 2, the operation command unit 58 of the processing unit 51 can detect the shape and the position of the surface 63a of the workpiece 62 in accordance with the position information of three-dimensional points. Then, the operation command unit 58 sends a position and an orientation in which the hand 5 should be placed to the operation control unit 43 in accordance with the position and the shape of the surface 63a. The operation control unit 43 controls the positions and the orientations of the robot 1 and the hand 5. In this manner, the position of the workpiece 62 can be detected, and the workpiece 62 can be conveyed by the robot apparatus 3.

FIG. 15 illustrates a perspective view of the light-receiving element and an optical center for describing the size of the evaluation region of the present embodiment. The evaluation region 92 can be set to any size. However, it is preferable to include at least one three-dimensional point inside the evaluation region 92. When the evaluation region 92 is too large, the number of three-dimensional points to be determined by the determination unit 54 is reduced.

In the example illustrated in FIG. 15, a virtual plane 97 is set with respect to the light-receiving element 96. The virtual plane 97 is a plane parallel to the light-receiving element 96. The virtual plane 97 is apart from an optical center 31c of the camera 31 by a distance d. The distance d is a distance from the camera 31 to the surface 63a of the workpiece 62. The distance d does not have to be an accurate distance as long as the distance d is an approximate distance. In the virtual plane 97, a region 97a that is symmetrical to one pixel 99 included in the light-receiving element 96 with respect to the optical center 31c is calculated. The size of the region 97a can be set to the size of the evaluation region 92. That is, the evaluation region 92 can be set to the size corresponding to one pixel on the surface 63a of the workpiece 62.

Note that the setting unit 56 of the processing unit 51 of the present embodiment sets predetermined evaluation regions, but the embodiment is not limited to this. The setting unit may be configured to be able to change the size or the shape of the evaluation region. For example, the setting unit can detect the shape of the workpiece and set the evaluation region to a size and in a shape corresponding to the shape of the workpiece. Further, the setting unit may set a plurality of types of setting regions having shapes and sizes different from each other for one workpiece in accordance with the shape of the workpiece.

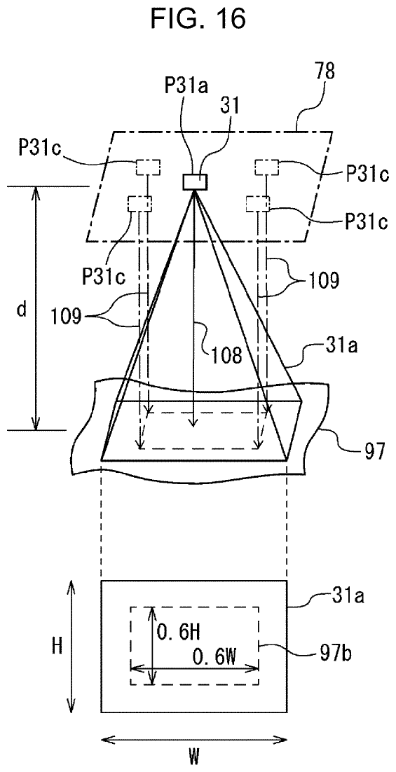

FIG. 16 illustrates a perspective view and a plan view of an imaging capturing region for describing the position of the camera when the camera is placed with respect to the workpiece. The camera 31 can be placed at any position so as to include at least part of a target portion of the workpiece 62 when a range image is captured by the camera 31. An arrow 108 indicates the optical axis of the camera 31 when the camera 31 is placed at the position P31a. In the example here, the position P31a is located directly above the center portion of the surface 63a of the workpiece 62.

In the example illustrated in FIG. 16, the virtual plane 97 apart from the movement plane 78 by the distance d is set. The image capturing region 31a on the virtual plane 97 is calculated. The image capturing region 31a has a quadrangular shape on the virtual plane 97. Then, a region 97b is set by multiplying the width W and the height H of the quadrangle of the image capturing region 31a by predetermined constants. In the example here, the region 97b is set by multiplying the width W and the height H by 0.6. Then, a position P31c of the camera 31 can be set so as to locate the optical axis indicated by an arrow 109 at the position corresponding to each corner of the region 97b. In other words, the camera 31 can be placed so as to arrange the optical axis at a vertex corresponding to an angle of view having a predetermined proportion to the angle of view of the camera. The camera 31 is placed at a plurality of the positions P31a and P31c along the movement plane 78.

Alternatively, as the position at which the camera is placed, it is possible to adopt a position in which the optical axis is arranged at an end portion of a region in which the workpiece is placed. Alternatively, the camera may be placed so as to arrange the optical axis at a position obtained by equally dividing a predetermined region.

In the embodiment described above, the workpiece including the wall portion erected on the surface of the plate portion has been described as an example, but the embodiment is not limited to this. The three-dimensional measurement device of the present embodiment can be applied to the measurement of any object on which light reception through multipath is generated.

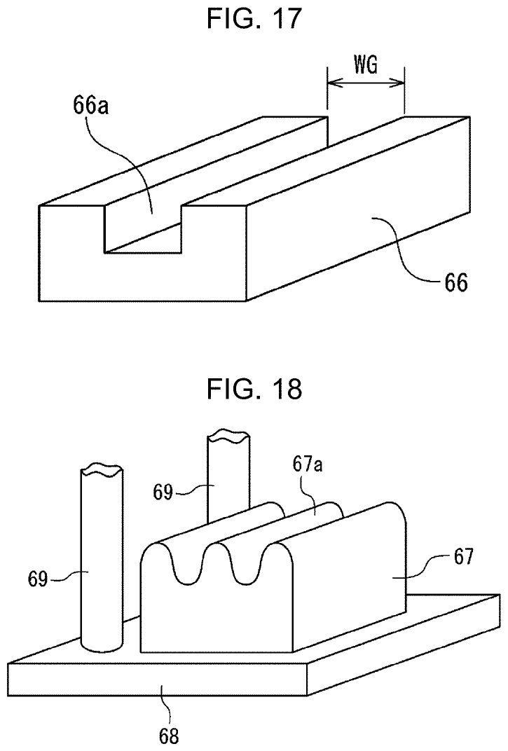

FIG. 17 illustrates a perspective view of a second workpiece of the present embodiment. A groove 66a is formed on the upper surface of a second workpiece 66. When the base surface of the groove 66a is detected, light may be reflected by a side surface of the groove 66a so as to generate light reception through multipath. The three-dimensional measurement device of the present embodiment can be used for measurement of a surface of a workpiece having a recess as described above.

It is preferable to capture a range image by placing the camera so as to arrange the optical axis at the position of the wall face of the groove 66a when the workpiece 66 has the groove 66a. Alternatively, it is preferable to set a plurality of image capturing positions of the camera on the movement plane at an interval corresponding to a width WG of the groove 66a. By performing this control, the influence of multipath that is generated at the time of detecting the base surface of the groove can be reduced more reliably.

FIG. 18 illustrates a perspective view of a third workpiece and a table of the present embodiment. In a third workpiece 67, the cross-sectional shape of a surface 67a is formed in a wave shape. Also, in the case of detecting the surface 67a having such recesses and protrusions, light reception through multipath may be caused.

Further, light reception through multipath may be generated by an object placed around the workpiece. In the example illustrated in FIG. 18, the workpiece 67 is placed on a table 68. A rod-shaped member 69 serving as a column is fixed to the table 68. The workpiece 67 is placed near the rod-shaped member 69. The surface 67a is detected by the camera 31, light reflected by the surface of the rod-shaped member 69 may travel toward the surface 67a so as to generate light reception through multipath. Also, in the case of detecting the surface 67a of the workpiece 67 with a device including the table 68, the position information of three-dimensional points with reduced influence of multipath can be acquired by measurements with the three-dimensional measurement device of the present embodiment. The three-dimensional measurement device of the present embodiment can generate the position information of three-dimensional points with reduced multipath even when it is unknown how multipath is generated.

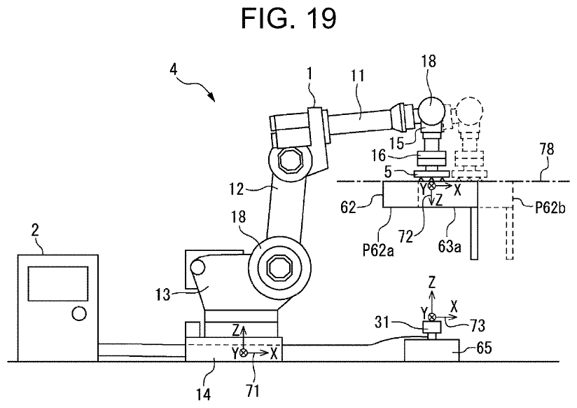

FIG. 19 illustrates a side view of a second robot apparatus of the present embodiment. In a second robot apparatus 4, the robot 1 supports the workpiece 62 via the hand 5. The camera 31 is fixed to a platform 65. In the second robot apparatus 4, the robot 1 functions as a movement device that moves the workpiece 62. When the robot 1 moves the workpiece 62, the relative position of the camera 31 to the workpiece 62 changes. Also in the second robot apparatus 4, the surface 63a of the workpiece 62 is detected.

The second robot apparatus 4 functions as a three-dimensional measurement device. The three-dimensional measurement device can detect the position of the workpiece 62 with respect to the hand 5, for example. The three-dimensional measurement device can detect misalignment in holding the workpiece 62. Alternatively, the three-dimensional measurement device can detect the shape of the surface 63a of the workpiece 62, for example. Alternatively, the three-dimensional measurement device can inspect the dimensions of the workpiece 62.

The robot 1 moves the workpiece 62 along the predetermined movement plane 78. The robot 1 translates the workpiece 62 while keeping constant the orientation of the workpiece 62. The movement plane 78 is, for example, a plane extending in a horizontal direction. The controller 2 changes the position and the orientation of the robot 1 so that the origin of the tool coordinate system 72 moves on the movement plane 78. Further, the controller 2 controls the orientation of the robot 1 so that the Z-axis of the tool coordinate system 72 faces in a predetermined direction.

The camera 31 captures range images with the workpiece 62 placed at a plurality of positions of the workpiece 62. In the example illustrated in FIG. 19, the camera 31 captures a first range image with the workpiece 62 placed at a first position P62a. Further, the camera 31 captures a second range image with the workpiece 62 placed at a second position P62b. The positions of three-dimensional points corresponding to the surface 63a of the workpiece 62 in each of the first range image and the second range image are represented in the camera coordinate system 73.

With reference to FIG. 2 and FIG. 19, the position acquisition unit 52 of the processing unit 51 acquires range images and acquires the position and the orientation of the robot 1 at the time of capturing the range images. The position acquisition unit 52 stores the range images in combination with the position and the orientation of the robot 1 in the storage unit 42.

After completion of the image capturing with the workpiece 62 placed at a plurality of the positions P62a and P62b, the processing unit 51 generates position information of the three-dimensional points obtained by synthesizing a plurality of range images. The conversion unit 53 converts the position information of the three-dimensional points represented in the camera coordinate system 73 into the position information of the three-dimensional points represented in the tool coordinate system 72 in accordance with the position and the orientation of the robot 1.

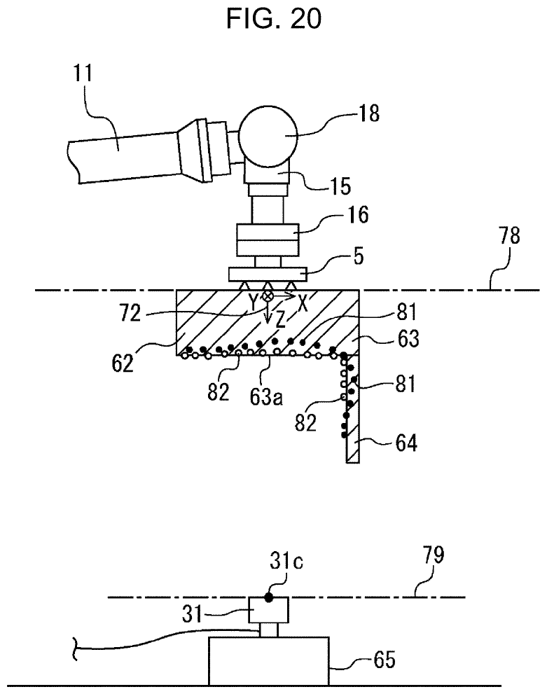

FIG. 20 illustrates a partial cross-sectional view of the workpiece and the camera when a plurality of three-dimensional points included in range images corresponding to a plurality of positions are arranged in the workpiece. The determination unit 54 arranges the three-dimensional point included in the first range image and the second range image in the workpiece 62. The three-dimensional points 81 included in the first range image and the three-dimensional points 82 included in the second range image are indicated on the surface 63a of the workpiece 62 and in the vicinity of the surface 63a. The three-dimensional points 81 and 82 are each represented in the tool coordinate system 72.

With reference to FIG. 2 and FIG. 20, the determination unit 54 calculates the positions of the three-dimensional points 81 and 82 when the workpiece 62 is placed at one position. For example, the positions of the three-dimensional points 81 and 82 when the workpiece 62 is placed at the first position P62a are calculated. Further, the determination unit 54 converts the position information of the three-dimensional points represented in the tool coordinate system 72 into the position information of the three-dimensional points represented in the world coordinate system 71 in accordance with the position and the orientation of the robot 1. A reference plane 79 for the determination unit 54 to determine the three-dimensional points 81 and 82 is predetermined. In the second robot apparatus 4, the reference plane 79 passing through the optical center 31c of the camera 31 is defined. In the example here, the reference plane 79 is a plane parallel to the movement plane 78.

Further, similar to the first robot apparatus 3, an evaluation range is predetermined so as to include the surface 63a of the workpiece 62. Inside the evaluation range, a plurality of evaluation regions extending in a perpendicular direction from the reference plane 79 is predetermined (see FIG. 12 and FIG. 13). The determination unit 54 determines the three-dimensional point closest to the reference plane 79 in each of the evaluation regions. The generation unit 55 can generate synthesized position information of three-dimensional points in accordance with the three-dimensional points determined by the determination unit 54.

Other configurations, operations, and effects of the second robot apparatus are similar to those of the first robot apparatus, and therefore the description thereof will not be repeated here.

In the first robot apparatus and the second robot apparatus, the camera or the workpiece is translated, but the embodiment is not limited to this. Both of the camera and the workpiece may be translated. For example, the camera and the workpiece may be translated in opposite directions along the movement plane. Further, the movement of the camera and the workpiece is not limited to translation along the movement plane, and image capturing may be performed at a position deviating from the movement plane. For example, when an obstacle is present on the movement plane, image capturing may be performed with the camera or the workpiece placed at a position away from the movement plane.

The movement device that moves the camera or the workpiece is not limited to a robot, and any device that can move the camera or the workpiece can be employed. For example, a device including a conveyor that conveys a workpiece, a device that moves a workpiece or a camera in an X-axis, a Y-axis, and a Z-axis direction orthogonal to each other, a device including a cylinder that moves a workpiece or a camera in one direction, or the like can be employed as the movement device.

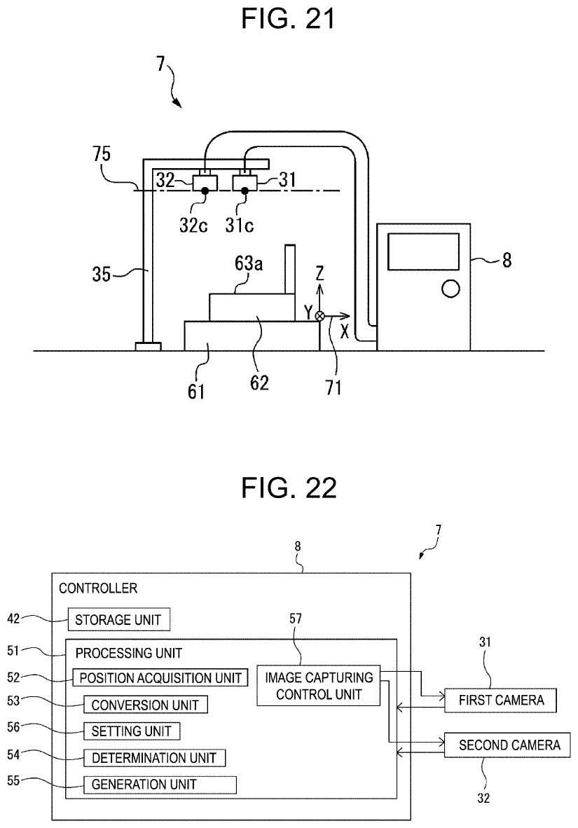

FIG. 21 illustrates a side view of an inspection device of the present embodiment. FIG. 22 illustrates a block diagram of an inspection device of the present embodiment. An inspection device 7 functions as a three-dimensional measurement device. The three-dimensional measurement device does not have to include a movement device such as the robot 1 described above. With reference to FIG. 21 and FIG. 22, the inspection device 7 includes a first camera 31 and a second camera 32 as a plurality of range cameras. Each of the cameras 31 and 32 is a TOF camera.

The cameras 31 and 32 are supported by a support member 35. The cameras 31 and 32 are fixed at positions apart from each other along a placement plane 75. The positions of the cameras 31 and 32 are predetermined. The cameras 31 and 32 are placed so as to capture images of the workpiece 62 at positions different from each other. The cameras 31 and 32 respectively have optical centers 31c and 32c located on the placement plane 75. Further, each of the cameras 31 and 32 is placed such that the optical axis faces in a predetermined direction. That is, the orientations of the cameras 31 and 32 are identical to each other. The workpiece 62 is placed on a platform 61. In this manner, the workpiece 62 and both of the cameras 31 and 32 are fixed at predetermined positions.

In the inspection device 7, the world coordinate system 71 as a reference coordinate system is set. In the example illustrated in FIG. 21, the world coordinate system 71 is set so as to arrange an origin on the surface of the platform 61. In addition, a camera coordinate system is set to each of the cameras 31 and 32. Each of the camera coordinate systems is set such that the optical center of each of the cameras 31 and 32 is the origin and the Z-axis overlaps the optical axis.

The inspection device 7 includes a controller 8 including an arithmetic processing device including a CPU. The controller 8 includes a storage unit 42 and a processing unit 51 similar to those of the controller 2 of the first robot apparatus 3 (see FIG. 2). The processing unit 51 includes an image capturing control unit 57 that controls the cameras 31 and 32. The processing unit 51 includes a position acquisition unit 52, a conversion unit 53, a setting unit 56, a determination unit 54, and a generation unit 55 in order to process range images acquired by the cameras 31 and 32.

While the robot 1 changes the image capturing position of the camera 31 in the first robot apparatus of the present embodiment, a plurality of cameras 31 and 32 is disposed in the three-dimensional measurement device illustrated in FIG. 21 and FIG. 22. Then, a plurality of range images are captured by the plurality of cameras 31 and 32 whose positions are different from each other. For example, the first camera 31 captures a first range image and the second camera 32 captures a second range image.

In the storage unit 42, the positions of the cameras 31 and 32 are stored in advance. The storage unit 42 stores range images captured by the camera 31 and the camera 32. The conversion unit 53 converts the position information of the three-dimensional points relative to the cameras 31 and 32 into the position information relative to the workpiece 62. In the example here, the conversion unit 53 converts the position information of the three-dimensional points detected in the camera coordinate systems of the respective cameras 31 and 32 into the position information of the three-dimensional points in the world coordinate system 71.

In the inspection device 7, a reference plane is predetermined. In the example here, a reference plane identical to the placement plane 75 is used. Any plane can be used as the reference plane. For example, the reference plane may be a plane parallel to the placement plane 75.

The setting unit 56 sets an evaluation range and evaluation regions. In the example here, the evaluation range and the evaluation region for evaluating the position of the three-dimensional point are predetermined. For example, the evaluation range is set so as to include the surface 63a of the workpiece 62 to be evaluated. The evaluation regions are set by dividing the evaluation range into a plurality of regions. Similar to the first robot apparatus 3, the evaluation region can be formed of a rectangular parallelepiped region extending in a direction perpendicular to the placement plane 75 that serves as the reference plane. The determination unit 54 can determine a three-dimensional point having the smallest distance from the placement plane 75 in each of the evaluation regions. The generation unit 55 can generate synthesized position information of three-dimensional points in accordance with the three-dimensional points determined by the determination unit 54.

The controller 8 can inspect the surface of the workpiece 62 in accordance with the synthesized position information of the three-dimensional points. For example, the controller 8 can inspect the dimensions of the outer edges of the workpiece in accordance with a predetermined determination value. Alternatively, when a recess or a protrusion is formed on the surface of the workpiece, the shape of the recess or the protrusion can be inspected.

In the example illustrated in FIG. 21 and FIG. 22, two cameras are disposed, but the embodiment is not limited to this. The three-dimensional measurement device may include three or more cameras. The three-dimensional measurement device can synthesize range images captured by a plurality of cameras. Other configurations, operations, and effects of the inspection device are the same as those of the first robot apparatus and the second robot apparatus of the present embodiment, and thus the descriptions thereof will not be repeated here.

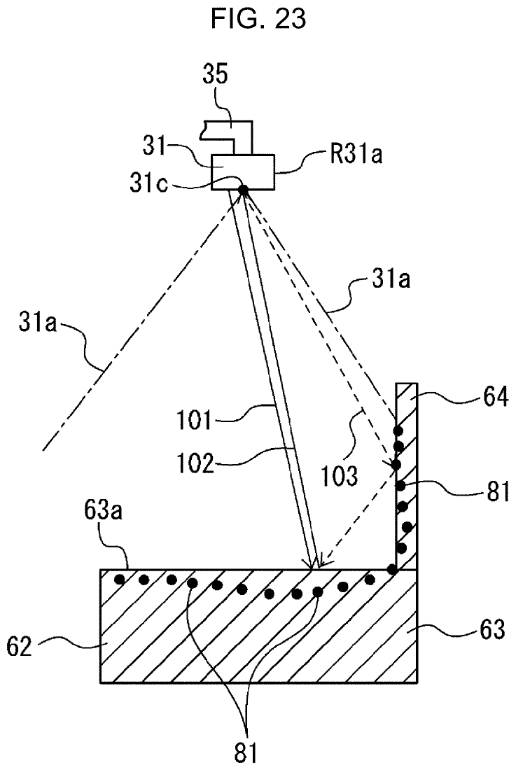

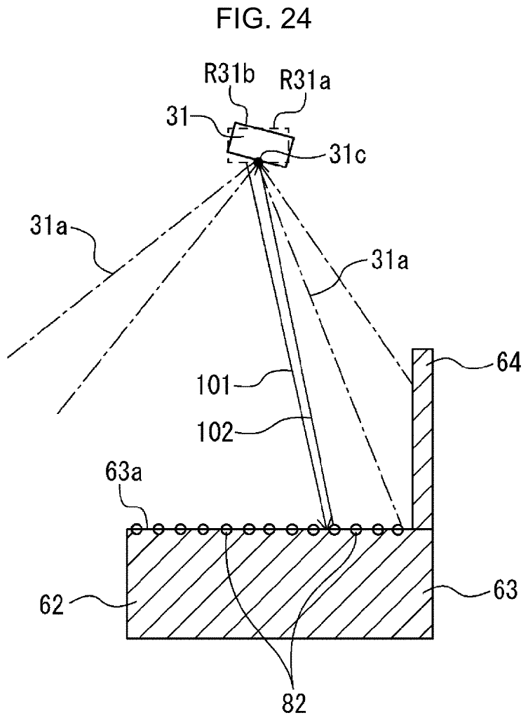

FIG. 23 illustrates a partial cross-sectional view of a camera and a workpiece in a third robot apparatus of the present embodiment. The configuration of the third robot apparatus is similar to that of the first robot apparatus (see FIG. 1). The third robot apparatus includes a rotation device that changes the relative orientation of the camera 31 to the workpiece 62. The robot 1 functions as a rotation device.

In the third robot apparatus, the relative orientation of the camera 31 to the workpiece 62 is changed and the camera 31 acquires position information of three-dimensional points. The robot 1 rotates the camera 31 around the optical center 31c of the camera 31 serving as a predetermined center point. The camera 31 captures range images in a plurality of predetermined relative orientations.

With reference to FIG. 2 and FIG. 23, the camera 31 captures a first range image in a first orientation R31a. The position information of three-dimensional points 81 corresponding to the surface 63a and the surface of the wall portion 64 of the workpiece 62 is acquired. The position acquisition unit 52 acquires the position and the orientation of the robot 1 at the time of capturing the first range image together with the first range image. The storage unit 42 stores the position and the orientation of the robot 1 in combination with the first range image. The position information of the three-dimensional points at this time is represented in the camera coordinate system.

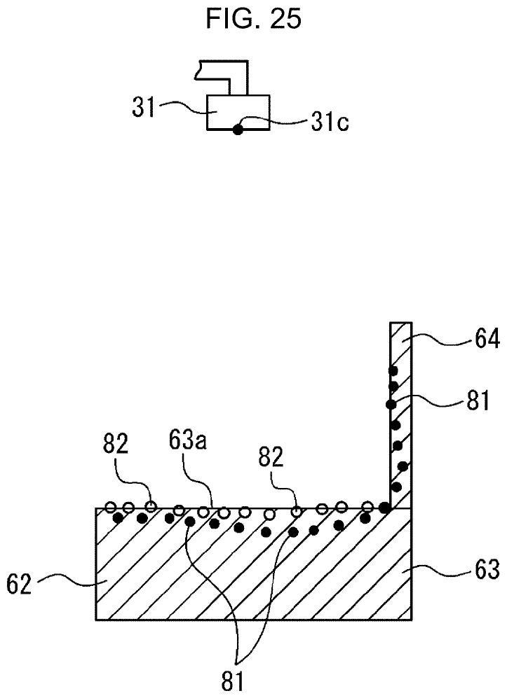

FIG. 24 illustrates a partial cross-sectional view of the camera and the workpiece when the camera is placed in a second orientation. When the robot 1 changes the position and the orientation, the camera 31 rotates around the optical center 31c as a rotational center. The camera 31 acquires a second range image in a second orientation R31b. In the example here, the wall portion 64 is located outside the image capturing region 31a of the camera 31. Thus, in the second range image, the position information of the three-dimensional points 82 arranged on the surface 63a of the workpiece 62 is acquired. The storage unit 42 stores the second range image in combination with the position and the orientation of the robot 1 at the time of capturing the second range image. The position information of the three-dimensional points at this time is represented in the camera coordinate system.

In the present embodiment, range images are captured in the two orientations R31a and R3 lb of the camera 31, but the embodiment is not limited to this. Range images may be captured in three or more orientations of the camera 31. After completion of the image capturing in all orientations of the camera 31, the conversion unit 53 converts the positions of the three-dimensional points 81 and 82 from the camera coordinate system 73 to the world coordinate system 71.

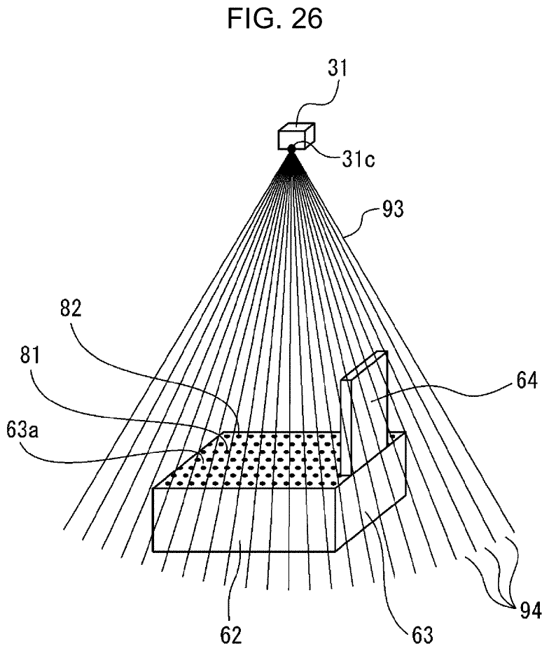

FIG. 25 illustrates a partial cross-sectional view of the camera and the workpiece when three-dimensional points acquired in a plurality of orientations of the camera are arranged in the workpiece. The determination unit 54 arranges the three-dimensional points 81 and 82 included in the first range image and the second range image in the workpiece 62.

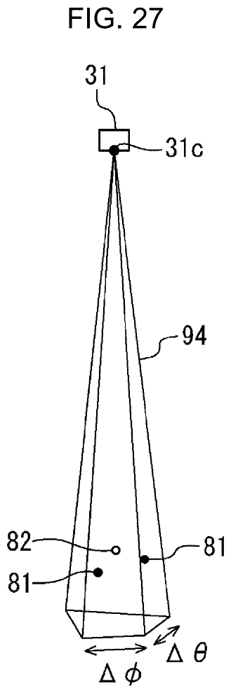

FIG. 26 illustrates a perspective view of an evaluation range for evaluating positions of three-dimensional points. FIG. 27 illustrates a perspective view of an evaluation region for evaluating positions of three-dimensional points. With reference to FIG. 26 and FIG. 27, the setting unit 56 sets an evaluation range and evaluation regions. In the third robot apparatus, evaluation regions 94 for evaluating the positions of the three-dimensional points corresponding to the surface 63a of the workpiece 62 are predetermined for the workpiece 62. A plurality of evaluation regions 94 are set inside an evaluation range 93. Each of the evaluation regions 94 is a region that extends radially from a reference point defined in advance with respect to the workpiece 62. The evaluation region 94 has a cone shape.

In the example here, the optical center 31c of the camera 31 is used as a reference point. That is, the reference point is the center point around which the camera 31 is rotated. The evaluation region 94 is set at an angle θ and an angle φ of a spherical coordinate system having the origin as the reference point. The reference point is not limited to this embodiment and can be located on the same side as the side on which the rotational center point of the camera is located with respect to the workpiece. That is, a reference point apart from the center point around which the camera 31 is rotated may be set.

The evaluation regions 94 are set by dividing the evaluation range 93 into a plurality of regions. The evaluation range 93 is a range extending radially around the optical center 31c. The evaluation range 93 preferably includes a part to be evaluated inside the evaluation range 93. In the example here, the evaluation range 93 is set so as to include the surface 63a of the workpiece 62 inside the evaluation range 93.

With reference to FIG. 2 and FIG. 27, the determination unit 54 determines the three-dimensional point closest to the optical center 31c as the reference point of the three-dimensional points 81 and 82 detected inside the evaluation region 94 in each of the evaluation regions 94. In the example illustrated in FIG. 27, since one three-dimensional point 82 is closer to the optical center 31c than two three-dimensional points 81, the determination unit 54 determines the three-dimensional point 82. The determination unit 54 performs the control for determining the three-dimensional point closest to the reference point for each of the evaluation regions 94.

FIG. 28 illustrates a cross-sectional view of the workpiece in which three-dimensional points determined by the determination unit are indicated. The three-dimensional point having the smallest distance from the reference point is extracted from among the plurality of three-dimensional points 81 and 82 illustrated in FIG. 25 in each of the evaluation regions 94. A three-dimensional point away from the surface of the workpiece 62 is excluded. Also in the third robot apparatus, the three-dimensional points 81 remains on the surface of the wall portion 64. The determination unit 54 can exclude the three-dimensional points 81 detected in correspondence with the surface of the wall portion 64 by any method. For example, the three-dimensional point 81 exceeding the predetermined range of position can be excluded.

With reference to FIG. 2 and FIG. 28, the generation unit 55 generates position information of three-dimensional points obtained by synthesizing pieces of position information of a plurality of three-dimensional points acquired by the camera 31 in accordance with the plurality of three-dimensional points determined by the determination unit 54. The generation unit 55 can generate a range image in accordance with the three-dimensional points 82 arranged in correspondence with the surface 63a of the plate portion 63 of the workpiece 62.

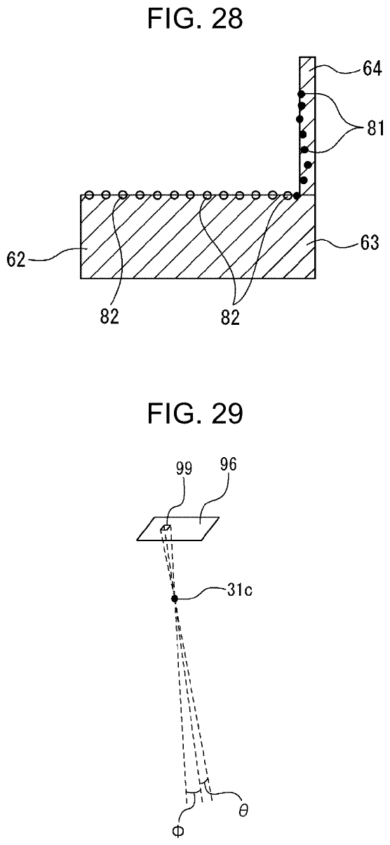

FIG. 29 illustrates a perspective view describing the size of the evaluation region in the third robot apparatus. The evaluation region 94 can be set to any size. In the present embodiment, one pixel 99 in the light-receiving element 96 of the camera 31 is determined. The angle θ and the angle φ in spherical coordinates can be set by straight lines that extend from the vertices of the pixel 99 to the optical center 31c. A region having a cone shape according to the angle θ and the angle φ can be set as the evaluation region 94. In this way, the angles corresponding to one pixel can be set as the angles of the cone shape of the evaluation region.

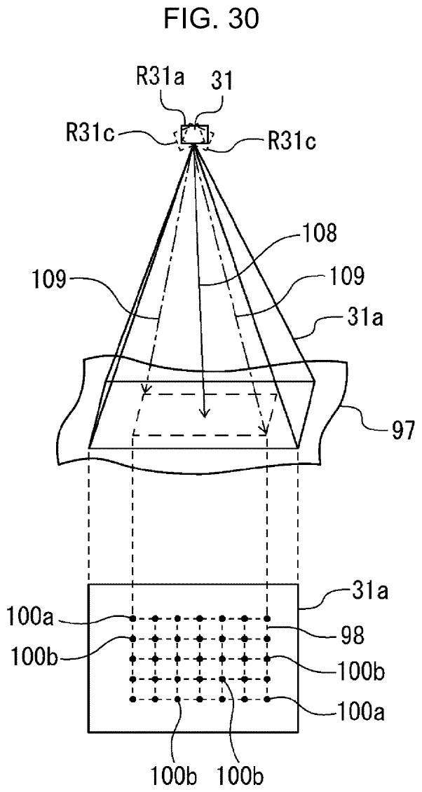

FIG. 30 illustrates a perspective view and a plan view of an image capturing region for describing the orientations of the camera when the camera is rotated. The angle at which the camera 31 is rotated can set to any angle. In the example here, the virtual plane 97 apart from the camera 31 is set. The virtual plane 97 is a plane perpendicular to the optical axis indicated by the arrow 108 when the camera 31 is placed in the first orientation R31a. In the image capturing region 31a on the virtual plane 97, it is possible to set a point corresponding to an angle of view having a predetermined proportion to the angle of view of the camera 31. Then, an orientation of the camera 31 can be set so as to arrange the optical axis of the camera 31 at this point. For example, in the image capturing region 31a on the virtual plane 97, it is possible to calculate a region 98 by multiplying the angle of view by a predetermined proportion. As indicated by the arrow 109, the orientation R31c of the camera 31 can be set so as to arrange the optical axis at the position of a vertex 100a of the region 98. Alternatively, the orientation R31c of the camera 31 can be set so as to arrange the optical axis at a point 100b obtained by equally dividing the region 98.

The third robot apparatus can also generate synthesized position information of three-dimensional points in accordance with the position information of the three-dimensional points acquired by rotating the camera 31. Accordingly, position information of three-dimensional points with reduced influence of multipath can be acquired.

Other configurations, operations, and effects of the third robot apparatus are similar to those of the first robot apparatus of the present embodiment, and therefore the description thereof will not be repeated here.

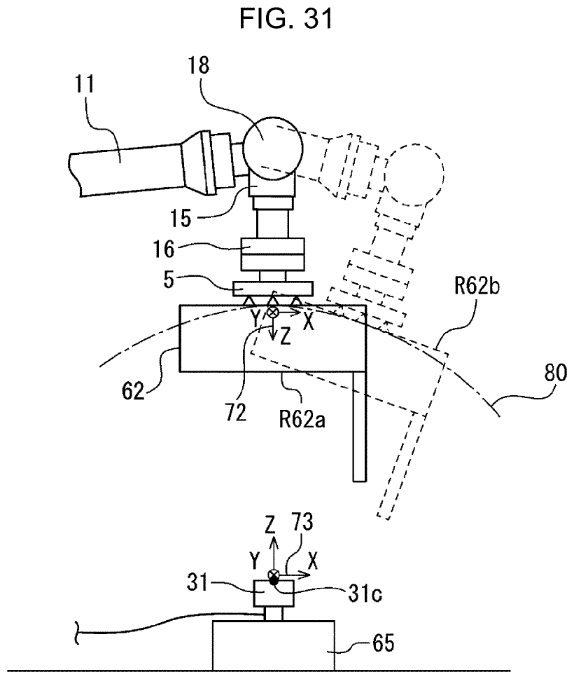

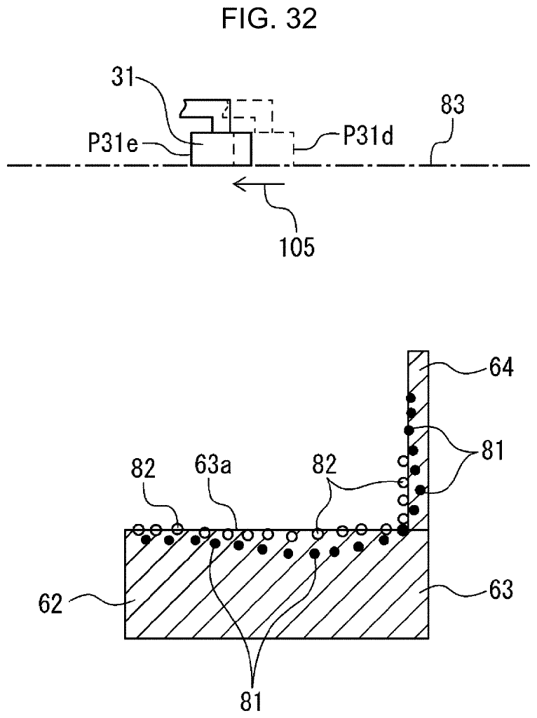

FIG. 31 illustrates a side view of a camera and a workpiece in a fourth robot apparatus of the present embodiment. The configuration of the fourth robot apparatus is similar to the configuration of the second robot apparatus (see FIG. 19). In the fourth robot apparatus, the position of the camera 31 is fixed. Then, the relative orientation of the camera 31 to the workpiece 62 is changed by changing the orientation of the workpiece 62. In the fourth robot apparatus, the robot 1 functions as a rotation device that changes the relative orientation of the camera 31 to the workpiece 62. The robot 1 rotates the workpiece 62 around the optical center 31c as a center point of rotation. The camera 31 captures range images with the workpiece 62 placed in a plurality of predetermined relative orientations of the workpiece 62 to the camera 31.

The controller 2 changes the position and the orientation of the robot 1 so as to arrange the origin of the tool coordinate system 72, which is a tool tip point, on a spherical surface 80 centered on the optical center 31c. The controller 2 changes the position and the orientation of the robot 1 such that the Z-axis of the tool coordinate system 72 faces the optical center 31c.

With reference to FIG. 2 and FIG. 31, the camera 31 captures a first range image with the workpiece 62 placed in a first orientation R62a of the workpiece 62. The position information of three-dimensional points output from the camera 31 are represented in the camera coordinate system 73. The position acquisition unit 52 stores the first range image in combination with the position and the orientation of the robot 1 in the first orientation R62a in the storage unit 42.

Next, the controller 2 changes the position and the orientation of the robot 1 so as to place the workpiece 62 in a second orientation R62b. The camera 31 captures a second range image. The position acquisition unit 52 stores the second range image in combination with the position and the orientation of the robot 1 in the second orientation R62b in the storage unit 42.

In the present embodiment, range images are captured with the workpiece 62 placed in the two orientations of the workpiece 62, but the embodiment is not limited to this. Range images may be captured in three or more orientations. The camera 31 captures range images with the workpiece 62 placed in all the orientations of the workpiece 62.

The conversion unit 53 converts the position information of the three-dimensional points acquired in each of the orientations R62a and R62b of the workpiece 62 and represented in the camera coordinate system 73 into the position information of the three-dimensional points represented in the tool coordinate system 72. The conversion unit 53 converts position information of three-dimensional points in accordance with the position and the orientation of the robot 1.

Next, the determination unit 54 arranges the position information of the three-dimensional points in the first range image and the position information of the three-dimensional points in the second range image on one surface of the workpiece 62. Here, the determination unit 54 selects any orientation of the workpiece 62. For example, the determination unit 54 selects one orientation of the workpiece 62 within a range in which the workpiece 62 is moved. In the present embodiment, the determination unit 54 selects the orientation R62a in which the Z-axis of the tool coordinate system 72 is located parallel to the vertical direction.

Next, the determination unit 54 converts the position information of the three-dimensional points represented in the tool coordinate system 72 into the position information of the three-dimensional points represented in the world coordinate system 71 in accordance with the position and the orientation of the robot 1 corresponding to the selected orientation of the workpiece 62. By performing this control, a state similar to the state illustrated in FIG. 20 in the second robot apparatus 4 is obtained.

The setting unit 56 sets an evaluation range and evaluation regions. In the fourth robot apparatus, an evaluation range and evaluation regions having a cone shape similar to those in the third robot apparatus are employed (see FIG. 26 and FIG. 27). A reference point for defining the evaluation regions can be set at any position relative to the workpiece 62. In the example here, the optical center 31c is set as a reference point. That is, the reference point is set to be the center point around which the workpiece 62 is rotated. The determination unit 54 determines the three-dimensional point closest to the reference point in each of the evaluation regions. The generation unit 55 can generate synthesized position information of three-dimensional points in accordance with the three-dimensional points determined by the determination unit 54.

Other configurations, operations, and effects of the fourth robot apparatus are similar to those of the first robot apparatus to the third robot apparatus, and therefore the description thereof will not be repeated here.

In the third robot apparatus and the fourth robot apparatus, a robot is employed as a rotation device that rotates a camera or a workpiece, but the embodiment is not limited to this. As a rotation device, any device that can rotate a camera or a workpiece around a predetermined center point may be employed. Further, a rotation device that rotates both of a camera and a workpiece may be employed.

FIG. 32 illustrates a partial cross-sectional view of a camera and a workpiece of a fifth robot apparatus of the present embodiment. The configuration of the fifth robot apparatus is similar to that of the first robot apparatus (see FIG. 1). The fifth robot apparatus includes a movement device that changes the relative position of the camera 31 to the workpiece 62. The robot 1 functions as a movement device.

In the first robot apparatus, the camera 31 is translated along the predetermined movement plane 78. With reference to FIG. 2 and FIG. 32, in contrast, in the fifth robot apparatus, the robot 1 changes the position and the orientation so that the camera 31 is translated along a predetermined movement line 83. The camera 31 is placed at a position along the movement line 83. For example, the optical center of the camera 31 is located on the movement line 83. At this time, the orientation of the camera 31 is kept constant.

After being placed at a first position P31d, the camera 31 captures a first range image. The three-dimensional points 81 corresponding to the surface of the workpiece 62 are detected. The position acquisition unit 52 stores the first range image with the position and the orientation of the robot 1 in the storage unit 42. Next, the robot 1 is driven so as to place the camera 31 at a position P31e. The camera 31 captures a second range image. The three-dimensional points 82 corresponding to the surface of the workpiece 62 are detected. The position acquisition unit 52 stores the first range image with the position and the orientation of the robot 1 in the storage unit 42.

The conversion unit 53 of the processing unit 51 converts the position information of the three-dimensional points represented in the camera coordinate system 73 into the position information of the three-dimensional points represented in the world coordinate system 71. The determination unit 54 determines a three-dimensional point closest to a reference line of the three-dimensional points 81 and 82 included in the first range image and the second range image.

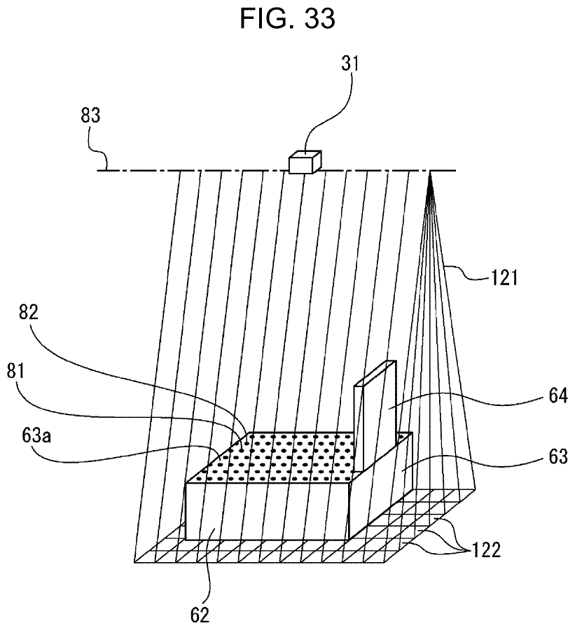

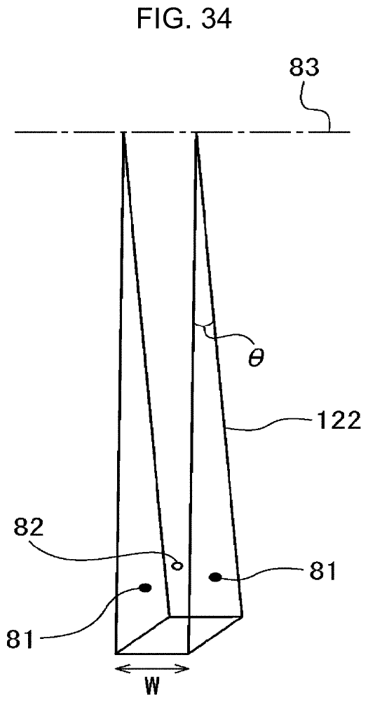

FIG. 33 illustrates a perspective view of a camera and a workpiece for describing an evaluation range in which evaluation regions are arranged in the fifth robot apparatus. FIG. 34 illustrates a perspective view of an evaluation region in the fifth robot apparatus. With reference to FIG. 33 and FIG. 34, in the fifth robot apparatus, a reference line is set in order to evaluate the positions of the three-dimensional points 81 and 82. Any line can be used as the reference line. The reference line is preferably the movement line 83 or a line parallel to the movement line 83. In the fifth robot apparatus, the movement line 83 is set as the reference line.

The setting unit 56 sets an evaluation range 121 and evaluation regions 122. The evaluation regions 122 are regions obtained by dividing the evaluation range 121 into a plurality of regions. The evaluation region 122 has a predetermined width along the movement line 83 as the reference line. The evaluation regions 122 are formed so as to extend radially from the movement line 83 to the workpiece 62. A width W of the evaluation region 122 can be set similar to the length of one side of the evaluation region 92 in the first robot apparatus. The width W can be set in accordance with a distance d from the camera 31 to the surface 63a of the workpiece 62 and the size of a pixel of the light-receiving element (see FIG. 15). Further, an angle θ of the evaluation region 122 can be set similar to the angle θ of the evaluation region 94 in the third robot apparatus. The angle 0 can be set in accordance with straight lines passing through the vertices of the pixel 99 and the optical center of the camera 31 (see FIG. 29).

The determination unit 54 calculates the distance from the movement line 83 to each of the three-dimensional points 81 and 82. In the example illustrated in FIG. 34, one three-dimensional point 82 is closer to the movement line 83 than two three-dimensional points 81. Thus, the determination unit 54 determines the three-dimensional point 82. The determination unit 54 performs the control for excluding the two three-dimensional points 81 from a set of three-dimensional points. In this manner, the determination unit 54 performs the control for determining the three-dimensional point closest to the reference line for each of the evaluation regions 122. The generation unit 55 of the processing unit 51 generates position information of three-dimensional points obtained by synthesizing pieces of position information of a plurality of three-dimensional points in accordance with the plurality of three-dimensional points 81 and 82 determined by the determination unit 54.

As described above, even when a plurality of range images are captured by moving the camera along the movement line, position information of three-dimensional points with reduced influence of multipath can be generated. Note that the positions of the cameras 31 at the time of capturing a plurality of range images can be set by a method similar to the method of setting the interval for the cameras 31 in the first robot apparatus (see FIG. 16).

Other configurations, operations, and effects of the fifth robot apparatus are similar to those of the first robot apparatus, and therefore the description thereof will not be repeated here.

Next, a sixth robot apparatus of the present embodiment will be described. The sixth robot apparatus is similar to the second robot apparatus 4 of the present embodiment (see FIG. 19 and FIG. 20). With reference to FIG. 19 and FIG. 20, in the second robot apparatus 4, the workpiece 62 is moved two-dimensionally along the movement plane 78. In contrast, in the sixth robot apparatus, the workpiece 62 is moved along a movement line instead of the movement plane 78. The movement line is a line extending in a predetermined direction. For example, the movement line is a line extending in the horizontal direction. The robot 1 translates the workpiece 62 while keeping constant the orientation of the workpiece 62.

In the second robot apparatus 4, the reference plane 79 is set so that the determination unit 54 determines the three-dimensional points 81 and 82. In contrast, in the sixth robot apparatus, a reference line is set in advance instead of the reference plane 79. The reference line is, for example, a line passing through the optical center of the camera 31. In the present embodiment, the reference line is set to be parallel to the movement line.

The camera 31 captures range images with the workpiece 62 placed at a plurality of positions of the workpiece 62. Similar to the fifth robot apparatus, the setting unit 56 sets an evaluation range and an evaluation range extending from the reference line (see FIG. 33 and FIG. 34). The determination unit 54 determines the three-dimensional point closest to the reference line in each of the evaluation regions. The generation unit 55 can generate synthesized position information of three-dimensional points in accordance with the three-dimensional points determined by the determination unit 54.

Other configurations, operations, and effects of the sixth robot apparatus are similar to those of the second robot apparatus and the fifth robot apparatus, and the description thereof will not be repeated here.

The first robot apparatus described above performs the control for determining a three-dimensional point close to the reference plane by moving the camera 31 along the movement plane and capturing a range image. The second robot apparatus performs the control for determining a three-dimensional point close to the reference plane by moving the workpiece 62 along the movement plane and capturing a range image. The third robot apparatus performs the control for determining a three-dimensional point close to the reference point by rotating the camera 31 around the center point and capturing a range image. The fourth robot apparatus performs the control for determining a three-dimensional point close to the reference point by rotating the workpiece 62 around the center point and capturing a range image. The fifth robot apparatus performs the control for determining a three-dimensional point close to the reference line by moving the camera 31 along the movement line and capturing a range image. The sixth robot apparatus performs the control for determining a three-dimensional point close to the reference line by moving the workpiece 62 along the movement line and capturing a range image. These controls for capturing range images and controls for determining a three-dimensional point to be kept in position information of three-dimensional points described above can be combined randomly.

For example, a control for determining a three-dimensional point close to a predetermined reference point may be performed by moving the camera 31 or the workpiece 62 along a movement plane and capturing a range image. Further, a control for determining a three-dimensional point close to a predetermined reference point may be performed by moving the camera 31 or the workpiece 62 along a movement line and capturing a range image. A control for determining a three-dimensional point close to a predetermined reference line may be performed by moving the camera 31 or the workpiece 62 along a movement plane and capturing a range image. A control for determining a three-dimensional point close to a predetermined reference plane may be performed by moving the camera 31 or the workpiece 62 along a movement line and capturing a range image. Furthermore, a control for determining a three-dimensional point close to the predetermined reference plane or reference line may be performed by rotating the camera 31 or the workpiece 62 around a center point and capturing a range image.

In addition, the robot 1 of the present embodiment functions as a change device that changes the relative position and the relative orientation of the camera 31 to the workpiece 62. The robot 1 may perform an operation of moving at least one of the camera 31 and the workpiece 62 along one movement plane or one movement line in combination with an operation of rotating at least one of the camera 31 and the workpiece 62 around a predetermined center point. For example, the robot apparatus moves the camera 31 along a movement plane so as to capture range images and further stops the movement of the camera 31 during a period of the movement along the movement plane. Then, the camera 31 may be rotated around a predetermined center point so as to capture range images. Alternatively, the robot apparatus may capture range images during a period in which an operation of translating the camera 31 and an operation of rotating the camera 31 are performed so that the workpiece 62 is always centered. In this case, the determination unit may perform any of the control for determining the three-dimensional point close to the predetermined reference point, the control for determining the three-dimensional point close to the predetermined reference plane, and the control for determining the three-dimensional point close to the predetermined reference line.

In each control described above, the order of the steps can be changed as appropriate unless the function and the effect are changed.

The above embodiment can be combined as appropriate. In each of the above-described drawings, the same or equivalent parts are denoted by the same reference numerals. It should be noted that the above-described embodiment is an example and does not limit the invention. In addition, the embodiment includes modifications of the embodiment described in the claims.

### REFERENCE SIGNS LIST

1 robot
2, 8 controller
3, 4 robot apparatus
7 inspection device
23 position detector
31, 32 camera
31c, 32c optical center
P31a, P31b, P31c, P31d, P31e position
R31a, R31b orientation
51 processing unit
52 position acquisition unit
53 conversion unit
54 determination unit
55 generation unit
56 setting unit
62, 66, 67 workpiece
P62a, P62b position
R62a, R62b orientation
71 world coordinate system
72 tool coordinate system
73 camera coordinate system
75 placement plane
78 movement plane
79 reference plane
81, 82 three-dimensional point
83 movement line
86, 87 range image
91, 93, 121 evaluation range
92, 94, 122 evaluation region
96 light-receiving element

1. A three-dimensional measurement device, comprising:
a range camera configured to acquire position information of three-dimensional points of a surface of an object in accordance with time of flight of light; and
a processing device configured to process the position information of the three-dimensional points acquired by the range camera, wherein
the range camera acquires the position information of the three-dimensional points at a plurality of relative positions and orientations of the range camera to the object, and
the processing device includes a setting unit configured to set a plurality of evaluation regions to the object for evaluating positions of three-dimensional points corresponding to the surface of the object,
a determination unit configured to determine, in each of the evaluation regions, a three-dimensional point closest to a reference plane, a reference point, or a reference line that is predetermined of a plurality of three-dimensional points detected within each of the evaluation regions, and
a generation unit configured to generate, in accordance with a plurality of three-dimensional points determined for each of the evaluation regions by the determination unit, position information of three-dimensional points obtained by synthesizing pieces of position information of a plurality of the three-dimensional points acquired by the range camera.

2. The three-dimensional measurement device according to claim 1, comprising a movement device configured to change a relative position of the range camera to the object, wherein
the movement device translates at least one of the object and the range camera along one movement plane while keeping an orientation of the at least one of the object and the range camera.

3. The three-dimensional measurement device according to claim 2, wherein
the determination unit determines a three-dimensional point closest to the reference plane, and
the reference plane is a plane identical to the one movement plane or a plane parallel to the one movement plane.

4. The three-dimensional measurement device according to claim 3, wherein the evaluation regions are regions extending in a direction perpendicular to the reference plane.

5. The three-dimensional measurement device according to claim 1, comprising a movement device configured to change a relative position of the range camera to the object, wherein
the movement device translates at least one of the object and the range camera along one movement line while keeping an orientation of the at least one of the object and the range camera.

6. The three-dimensional measurement device according to claim 5, wherein
the determination unit determines a three-dimensional point closest to the reference line, and
the reference line is a line identical to the one movement line or a line parallel to the one movement line.

7. The three-dimensional measurement device according to claim 6, wherein
the evaluation regions are regions extending radially from the reference line to the object.

8. The three-dimensional measurement device according to claim 2, wherein the movement device includes an articulated robot.

9. The three-dimensional measurement device according to claim 1, comprising a plurality of the range cameras, wherein
the plurality of the range cameras is fixed at positions apart from each other on one placement plane with orientations of the range cameras identical to each other, and
the determination unit determines a three-dimensional point closest to the reference plane or the reference line.

10. The three-dimensional measurement device according to claim 1, comprising a rotation device configured to change a relative orientation of the range camera to the object, wherein
the rotation device rotates at least one of the object and the range camera around a predetermined center point.

11. The three-dimensional measurement device according to claim 10, wherein the determination unit determines a three-dimensional point closest to the reference point.

12. The three-dimensional measurement device according to claim 11, wherein the evaluation regions are regions extending radially from the reference point to the object.

13. The three-dimensional measurement device according to claim 10, wherein the rotation device includes an articulated robot.

14. The three-dimensional measurement device according to claim 1, comprising a change device configured to change a relative position and orientation of the range camera to the object, wherein
the change device performs an operation of moving at least one of the object and the range camera along one movement plane or one movement line, and an operation of rotating at least one of the object and the range camera around a predetermined center point.

15. The three-dimensional measurement device according to claim 14, wherein the change device includes an articulated robot.

16. The three-dimensional measurement device according to claim 1, wherein
an evaluation range corresponding to a part in which the object is detected is predetermined, and
the evaluation regions are regions into which the evaluation range is divided.
